(19) United States
(12) Patent Application Publication
(10) Pub. No.: US 2026/0195134 A1
(43) Pub. Date: Jul. 9, 2026

(54) EFFICIENT LOAD VALUE PREDICTION BASED ON PROGRAM CONTEXT AND MISPREDICTION CONTROL MECHANISM FOR PIPELINED MICROPROCESSOR DESIGNS

(71) Applicant: HUAWEI TECHNOLOGIES CO., LTD., Shenzhen (CN)

(72) Inventors: Kleovoulos Kalaitzidis, Zurich (CH); Konstantin Berestizshevsky, Munich (DE); Leeor Peled, Hod Hasharon (IL); Elki Ravitz, Munich (DE); Lixia Yang, Beijing (CN)

(73) Assignee: HUAWEI TECHNOLOGIES CO., LTD., Shenzhen (CN)

(21) Appl. No.: 19/559,469

(22) Filed: Mar. 6, 2026

Related U.S. Application Data
(63) Continuation of application No. PCT/CN2023/117129, filed on Sep. 6, 2023.

(51) Int. Cl. G06F 9/38

(52) U.S. Cl. CPC G06F 9/3832; G06F 9/3802

(57) ABSTRACT

Described is a computing apparatus (800) for value prediction in concurrent instruction execution (406), the computing apparatus (800) being configured to: obtain a load value (511) of an executed instruction (101); enter at least part (601) of the load value (511) into a training table (503); and in dependence on the load value (605) having a training table confidence level (602) above a training table confidence threshold, enter the load value (511) into a value table (504), the value table comprising one or more load values (605) of a corresponding one or more instructions for use as predicted values (408) in the concurrent instruction execution (406). In this way, the load value (511) is only available for use as a predicted value (408) if the level of confidence is at a high enough level.

### CROSS-REFERENCE TO RELATED APPLICATIONS

This application is a continuation of International Application No. PCT/CN2023/117129, filed on Sep. 6, 2023, the disclosure of which is hereby incorporated by reference in its entirety.

### FIELD OF THE INVENTION

This invention relates to an apparatus and method for value prediction in concurrent instruction execution.

### BACKGROUND

Current flagship processors tend to employ large instruction windows to extract more instruction-level-parallelism (ILP) or otherwise to increase the processor's reach, i.e., the number of instructions that the processor can handle concurrently. Nonetheless, simple provisioning of larger microarchitecture/microarchitectural (uarch) structures/components is not always enough to effectively increase the amount of the instructions being executed per cycle (IPC), since programs may have inherent ILP limitations that are faithfully dictated by the true data dependencies between instructions, i.e., those described by typical consumer-producer schemes, where some instruction produces the input of some instruction that follows in the stream.

FIG. 1 schematically illustrates a re-order buffer 100 where data dependencies prevent the concurrent instruction execution. FIG. 1 demonstrates the example where the instruction I2 (consumer) 101b can execute only after the load instruction I1 (producer) 101a has executed and defined the value of register x1. Accordingly, the rest of the instructions 101c, 101d that follow need to also be blocked until after the load instruction I2 101b has executed and read the data from memory. Eventually, the number of cycles that the execution engine will stall is not fixed since it depends on the load latency, and thus, it may end up being fairly large. Such a case of data dependency represents a major performance bottleneck of modern processors.

Value Prediction (VP) is a key mechanism for collapsing such restricting execution dependencies by allowing dependent instructions to execute ahead of time using speculative sources (inputs), and thus, unlocking artificially some additional ILP (i.e., beyond what the program inherently has).

FIG. 2 schematically illustrates a re-order buffer 200 where data dependencies do not completely prevent the concurrent instruction execution. FIG. 2 demonstrates the benefit achievable by value prediction through the elimination of the dependence between the instruction I2 101b the load instruction I1 101b: by being able to predict the value loaded by instruction I1 1-3a in the register x1, I2 101b can start execution in parallel and subsequently allows the rest of the instructions 101c, 101d to start their execution earlier than before. That is, the total execution time of the instructions is shifted back in time, reducing execution latency overall by increasing the throughput of the execution engine or otherwise the observed ILP.

The main observation that enables value prediction is that ordinary programs, for the most part, do not behave randomly. Rather, they tend to exhibit a certain regularity in the flow and in the products of their operations. As such, by isolating these program “idiosyncrasies”, there is the ability to devise automata (predictors) that are capable of guessing program-related execution information. In this case, the focus is over the value patterns of instructions. Previous work [“Leveraging Value Equality Prediction for Value Speculation”, ACM TACO] has shown the prevalence of instructions with recurrent values in standard programs and has demonstrated the challenges of designing value predictors that can learn effectively the value sequences of instructions, when those are long or quite short.

Also, as any other speculative mechanism, VP implementation comes with certain risks and trade-offs that may drastically limit its effectiveness. A value misprediction requires recovery of the instructions that executed with bogus values; not only those directly consuming a predicted value, but also any other value on the same data-flow path. Similar to the prediction of branch directions (BP), the penalty of a value misprediction varies depending on the processor's depth (pipeline stages) and the instructions scheduling, since a predicted value is validated only after the predicted instruction has actually executed in the core. Since that penalty may be quite high, realistic (product-level) designs that feature value prediction mechanisms may need to be “bullet-proof” to avoid diminishing returns.

There has been a number of previous works related to VP. Below is provided a summary of a few publicly available key proposals grouped in three categories with the aim of facilitating the understanding of the present application:
1. Context-based: This category groups predictors that leverage some program context to associate instructions with values observed previously at their execution. The most fundamental and early model related to context-based VP is the last value predictor (LVP) [“Value locality and load value prediction”, ACM SIGPLAN] that predicts whether the current instruction value is equal to the last execution of the same instruction. Therefore, the context used in that case may be straightforward and simple, resembling the identity function. Most recently, VTAGE [“Practical data value speculation for future high-end processors”, HPCA] was introduced as a rather advanced LVP model that associates instructions with several (more than one) values based on their correlation with the branch history observed each time at their execution. Context-based predictors generally refer to mechanisms that predict values that have already been recorded and trained upon during the program's execution.
2. Computational: This class encompasses predictors that practically compute the instruction's value using a function of its previously produced values. The Stride [“Using value prediction to increase the power of speculative execution hardware”, ACM TOCS] predictor is a representative example of this category which predicts the current value by adding to the previous value a fixed difference (stride). Note that the prediction mechanism may also be based on some program context to learn the different strides, but its functionality (computational) remains the same.
3. Hybrids: Such predictors are able to predict both instruction values that repeat over time and also instruction values that follow a stride-based pattern, graciously combining the context-based value prediction and the computational logic. D-VTAGE [“BeBoP: A Cost-Effective Predictor Infrastructure for Superscalar Value Prediction”, HPCA] is the most recent and representative predictor of this class. D-VTAGE practically combines the VTAGE logic with a Stride predictor.

FIG. 3 is a table of coverage of regular value patterns from different predictor classes. FIG. 3 classifies the most regular value patterns, as dictated by previously published work, into the predictor category that covers them. A predictor is said to cover a pattern if its design allows it to learn and predict such a pattern. As expected, hybrid models are expected to cover all three value patterns listed, whereas context-based and computation models alone are focused on two of them. Since constants/recurrent values appear to be the most prominent or typically observable value patterns [“Leveraging Value Equality Prediction for Value Speculation”, ACM TACO], the interest in this invention is concentrated on them.

Below is a brief description of the main previous works.

Value locality and load value prediction [“Value locality and load value prediction”, ACM SIGPLAN]. Performing load value prediction with a PC-indexed tag-less (direct mapped) table holding previously seen load values. Predictable loads may be identified by a separate classification table (PC-indexed, direct mapped) with confidence counters.

Using value prediction to increase the power of speculative execution hardware [“Using value prediction to increase the power of speculative execution hardware”, ACM TOCS]. The predicted value may be the sum of the last value and the stride. Extension of LVP by extending each entry with the “stride” being the difference between two recent consecutive values.

Practical data value speculation for future high-end processors (VTAGE) [“Practical data value speculation for future high-end processors”, HPCA]. Value prediction based on the TAGE branch predictor algorithm, using branch history contexts, and attempting to allocate an entry for any combination of branch history context and instruction value observed, trained with committed load values (full-length values). A tag-less LVP predictor may be used as the base predictor component (not context-based). It may be assumed that predicted values will be communicated through registers using extra PRF ports without specific design for a practical microarchitecture (uarch) but mentioning the possibility of limiting the number of predicted instructions per fetch block.

BeBOP: A Cost-Effective Predictor Infrastructure for Superscalar Value Prediction (D-VTAGE) [“BeBOP: A Cost-Effective Predictor Infrastructure for Superscalar Value Prediction”, HPCA]. Improvement over VTAGE where instead of whole values, the predictor stores the value strides (differences) calculated over any observed branch history context, which are added to the respective last values in order to generate value predictions. The base predictor component (not context-based) may be a tag-less stride predictor.

Exploring value prediction with the EVES predictor (EVES) [“Exploring value prediction with the EVES predictor”, CVP1]. Similar to VTAGE but assuming shared storage with the number of banks being equal to the number of branch-history-contexts (several being different in length). Shorter value hashes are initially stored before a certain confidence threshold is reached to store the full value; still by attempting to allocate entries without filtering out short value sequences (i.e., for any different context-value couple that is observed).

Focused Value Prediction [“Focused Value Prediction”, ISCA]. Value prediction with branch history context for a few selected loads identified as critical dynamically due to blocking instruction retirement/ROB; the patent mentions identifying H2P branches/delinquent loads through PMUs and allocating for prediction their providers and only if those are loads. Agnostic to the way of communicating predicted values to consumers; the patent mentions that the predicted value is put in the reservation station for the source operand of the corresponding consumer instruction.

Leveraging Targeted Value Prediction to Unlock New Hardware Strength Reduction Potential [“Leveraging Targeted Value Prediction to Unlock New Hardware Strength Reduction Potential”, MICRO]. Value prediction based on VTAGE but targeting only small values that can be represented by the register reference numbers (in terms of bit length). Predicted values may be used for performing dynamic strength reduction of certain operations when possible.

Overall, three potential issues in prior work have been identified:
1. Suboptimal use of system resources for training: All potentially predictable instructions train/update the predictor structures. When an instruction happens to produce the same value in short intervals of successive executions, their rapid change may cause thrashing in the predictors tables (caches). This thrashing is essentially a removal of useful information which could be used for confidently predicting other instructions' values.
2. Suboptimal use of program contexts for learning recurrent values: Instructions may attempt to train the predictor for any combination of observed program contexts and respective values without pre-evaluating their predictability over that specific context instance. Program contexts that tend to lead to value mispredictions and execution recovery (pipeline squash and instruction fetch re-steer) may not be meticulously tracked and recorded. Therefore, future predictions over them may not be throttled and mispredictions may not be prevented. Furthermore, in the absence of a proper throttling mechanism, instructions with different values over several context instances may increase unnecessarily the predictor's storage budget requirements (combined with issue 1). The eviction of entries allocated for more “stable” instructions can impact substantially the accuracy/coverage of the predictor.
3. Suboptimal and/or unclear communication and validation of predicted values: Most academic works largely obfuscate or make assumptions on how the predicted values are communicated to the dependent instructions that follow in the instruction stream. In some cases, it is assumed that additional PRF/loads ports are within the realm of an actual product design, whereas in some other cases, some extra structures are assumed to take over the propagation of predictions. These are rather strong assumptions, which may not be implementable in a real product.

It is desirable to develop an apparatus and method that overcomes the above problems.

### SUMMARY

According to a first aspect, there is provided a computing apparatus for value prediction in concurrent instruction execution, the computing apparatus comprising one or more processors and a memory storing program code, wherein the program code is executable by the one or more processors so that the computing apparatus is configured to: obtain a load value of an executed instruction; enter at least part of the load value into a training table; and in dependence on the load value having a training table confidence level above a training table confidence threshold, enter the load value into a value table, the value table comprising one or more load values of a corresponding one or more instructions for use as predicted values in the concurrent instruction execution. In this way, the load value is only available for use as a predicted value if the level of confidence is at a high enough level.

In some implementations, the computing apparatus may be configured to enter a folded hash of the load value into the training table. In this way, the memory required to store the load value in the training table is reduced when the full load value details are not required.

In some implementations, the training table confidence level may be based on a training table count value of previous load values for the corresponding executed instruction entered into the training table. In this way, the confidence may increase the more the load value is received at the training table.

In some implementations, the computing apparatus may be configured to replace a previous at least part of the load value for the executed instruction in the training table with the current at least part of the load value for the executed instruction in dependence on the current load value differing from the previous load value. In this way, if there is an error in the load value in the training table the erroneous load value is removed.

In some implementations, the computing apparatus may be configured to enter a full load value into the value table. In this way, the full details of the load value are included in the value table.

In some implementations, the computing apparatus may be configured to use a load value in the value table as a predicted value for the corresponding instruction in the concurrent instruction execution. In this way, the concurrent instruction execution may be optimised.

In some implementations, the computing apparatus may be configured to use the load value in the value table as a predicted value for the corresponding instruction by injecting a further instruction to write the predicted value in the destination register of the corresponding instruction. In this way, the injection of load values may be optimised.

In some implementations, the computing apparatus may be configured to use a load value in the value table as a predicted value for the corresponding instruction in the concurrent instruction execution in dependence on the load value having a value table confidence level above a value table confidence threshold. In this way, the load value is only used as a predicted value if the level of confidence is at a high enough level.

In some implementations, the value table confidence level may be based on a value table count value of previous load values for the corresponding executed instruction entered into the value table. In this way, the confidence may increase the more the load value is received at the value table.

In some implementations, the computing apparatus may be configured to reduce the value table confidence level for the load value in dependence on the current load value differing from the previous load value. In this way, if there is an error in the load value in the value table the erroneous load value may have the confidence reduced.

In some implementations, the computing apparatus may be configured to use a load value in the value table as a predicted value for the corresponding instruction in the concurrent instruction execution in dependence on the context of the corresponding instruction in the concurrent instruction execution matching the context of the load value in the value table. In some implementations, the context may comprise branch history of the corresponding instruction. In this way, the apparatus may check if there is an available load value based on the context of the instruction.

In some implementations, the computing apparatus may be configured to use the load value from the value table as a predicted value for the corresponding instruction in the concurrent instruction execution in dependence on the context of the corresponding instruction in the concurrent instruction execution differing from the context in a prediction throttling table for the corresponding instruction, the prediction throttling table comprising one or more context in which the load value of the corresponding instruction has previously been incorrectly predicted. In some implementations, the context may comprise branch history of the corresponding instruction. In this way, use of the load value as a predicted value may be restricted if the load value previously caused an error during execution for the particular context of the instruction.

In some implementations, in dependence on an instruction in the concurrent instruction execution inherently defining the same value irrespective of the input, the apparatus may be configured to use the value of the instruction in the concurrent instruction execution without executing the instruction. In this way, instructions may not be executed if they do not need to be.

In some implementations, the computing apparatus may be configured to fetch a plurality of instructions to be executed in an order. In this way, the apparatus may obtain the instructions.

In some implementations, the computing apparatus may be configured to decode each of the plurality of instructions. In this way, the instructions may be converted in a form to be executed.

In some implementations, the computing apparatus may be configured to order the decoded plurality of instructions in a re-order buffer in dependence on predicted values for the plurality of instructions available for use from the value table. In some implementations, the computing apparatus may be configured to execute the plurality of instructions based on the re-order buffer so as to carry out the concurrent instruction execution. In this way, the instructions may be executed in a more optimal order.

According to a second aspect, there is provided a method for value prediction in concurrent instruction execution, the method comprising steps of: obtaining a load value of an executed instruction; entering at least part of the load value into a training table; and in dependence on the load value having a training table confidence level above a training table confidence threshold, entering the load value into a value table, the value table comprising one or more load values of a corresponding one or more instructions for use as predicted values in the concurrent instruction execution.

### BRIEF DESCRIPTION OF THE FIGURES

The present invention will now be described by way of example with reference to the accompanying drawings. In the drawings:

FIG. 1 schematically illustrates a re-order buffer where data dependencies prevent the concurrent instruction execution.

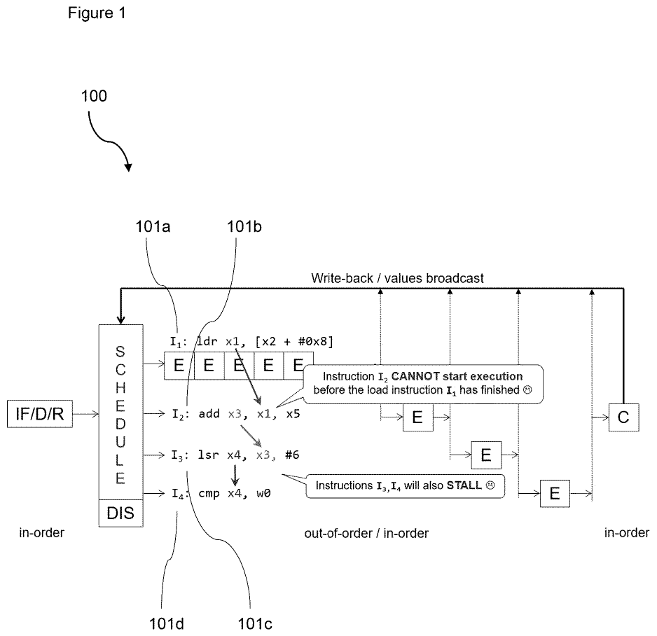

FIG. 2 schematically illustrates a re-order buffer where data dependencies do not completely prevent the concurrent instruction execution.

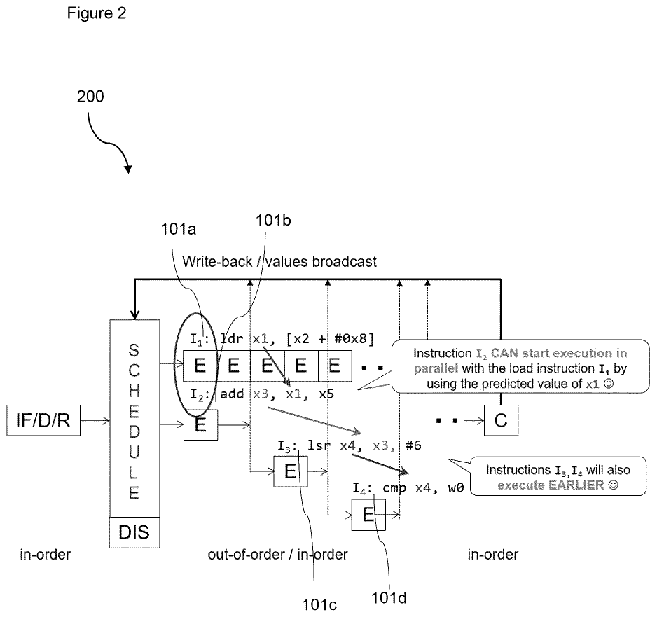

FIG. 3 is a table of coverage of regular value patterns from different predictor classes.

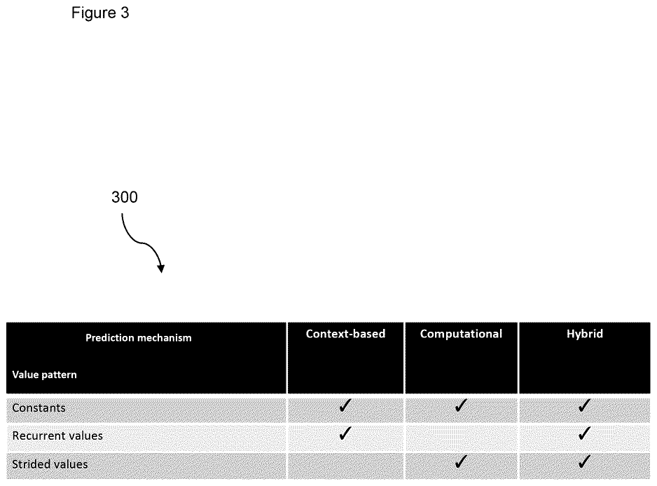

FIG. 4 schematically illustrates an exemplary concurrent instruction execution pipeline of the present application.

FIG. 5 schematically illustrates an exemplary concurrent instruction execution pipeline including details of a value prediction unit of the present application.

FIG. 6A shows an exemplary training table of the present application. FIG. 6B shows an exemplary value table of the present application. FIG. 6C shows an exemplary prediction throttling table of the present application.

FIG. 7 shows an example of a computer implemented method for value prediction in concurrent instruction execution.

FIG. 8 shows an example of an apparatus configured to perform the methods described herein.

### DETAILED DESCRIPTION

The apparatuses and methods described herein concern value prediction in concurrent instruction execution.

Embodiments of the present invention may tackle one or more of the problems previously mentioned by: in dependence on the load value having a training table confidence level above a training table confidence threshold, enter the load value into a value table, the value table comprising one or more load values of a corresponding one or more instructions for use as predicted values in the concurrent instruction execution. In this way, the load value is only available for use as a predicted value if the level of confidence is at a high enough level.

The present system may aim to cover a comprehensive method and design to implement a cost-effective load value prediction microarchitecture design that is able to predict recurrent values of load instructions using distinctive program context and a misprediction control mechanism for performing prediction throttling.

The present system may enable a comprehensive system with effective context-based value prediction by being able to filter out instructions with short sequences of recurrent values that cause thrashing of the state of existing value predictors and/or by throttling predictions that appear over contexts that lead to mispredictions. The mechanism may also enable a cost-effective communication of the predicted values by injecting a micro-operation (uop) to write the predicted value in the respective register. The micro-operation may be a move immediate operation. For example, a MOVI operation may be used without requiring extra PRF ports, whereas certain operations are eliminated when the predicted value is zero (0) or one (1).

The technical challenges that may be solved by the present system are summarized below:

Training without explicit filtering of load instructions with intervals of recurrent values that are not long enough to reach the confidence threshold, causing redundant thrashing of the predictor's state and a superfluous increase of the required storage budget.

Superfluous use of program context for learning and caching the recurrent load values of programs.

Indexing of the predictor for multiple loads within the same cycle.

Communication of predicted load values to consumers.

Lack of a mechanism/method for preventing value prediction over certain program contexts that tend to frequently lead to mispredictions.

Lack of a mechanism/method for avoiding operations that become redundant when one of their source operands, which is the predicted value of a load uop, is either zero (0) or one (1).

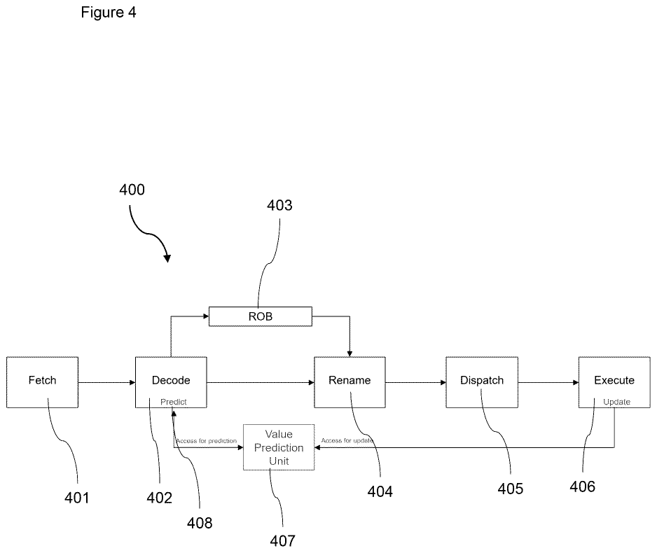

FIG. 4 schematically illustrates an exemplary concurrent instruction execution pipeline 400 of the present application. The pipeline 400 may be implemented on a computing apparatus as described herein.

The apparatus may obtain one or more instructions 101 for execution. The apparatus may obtain the instructions 101 from a user. The user may input the one or more instructions 101. The pipeline 400 may comprise a fetch module 401. The fetch module 401 may fetch the instructions 101. The instructions 101 may be executable in an order. There may be a particular order in which the instructions 101 must be executed. For example, the load value 511 output of an instruction 101 may be required as an input to a subsequent instruction.

The apparatus may decode the one or more instructions 101. The apparatus may decode the instructions into respective micro-operations (uops). The pipeline 400 may comprise a decode module 402. The decode module 402 may decode the instructions 101.

The apparatus may reorder the instructions 101. The apparatus may reorder the instructions 101 into an optimal order for execution. The pipeline 403 may comprise a reorder buffer (ROB) 403. The ROB 403 may reorder the instructions 101. The ROB 403 may reorder the decoded instructions 101.

The apparatus may receive a predicted value 408 for one or more of the instructions 101. The predicted value 408 may be used as an output load value 511 for the corresponding instruction 101. The corresponding instruction 101 may be the instruction 101 which outputs the load value 511 (as described herein) in question. The pipeline 400 may comprise a value prediction unit 407. The value prediction unit 407 may provide the predicted value 408. The value prediction unit 407 may output the predicted value 408 to be used as an output load value for the corresponding instruction 101. The value prediction unit 407 may receive as an input one or more instructions 101. Based on the one or more instructions 101, the value prediction unit 407 may output a predicted value for one or more of the inputted instructions 101. The value prediction unit 407 may not output a predicted value 408 for each instruction 101. The value prediction unit 407 may output a predicted value 408 for none, some, or all the instructions 101.

The apparatus may re-order the decoded instructions 101 in dependence on the one or more predicted values 408. The ROB 403 may receive the predicted values 408 from the value prediction unit 407. The ROB 403 may adapt the order of the instructions in dependence on whether a predicted value 408 can be used for one or more of the instructions 101. This may allow one or more of the instructions 101 to be executed in parallel. For example, if the predicted value 408 can be used for as subsequent instruction, rather than waiting for the load value 511 of the previous instruction 101. In this way, the instruction level parallelism may be improved.

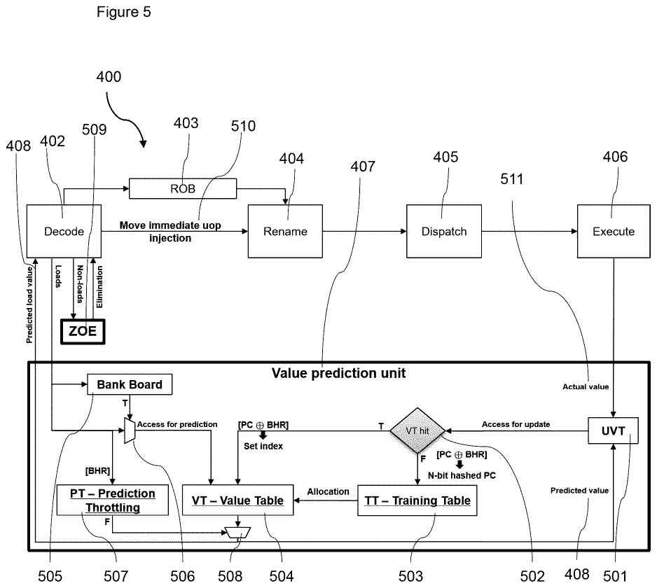

The apparatus may rename the instructions 101. Renaming the instruction may imply renaming its source and the destination registers from their architectural names into physical names. This step may be necessary to enable the operation of the concurrent ROB (403). The pipeline 400 may comprise a rename module 404. The decoded instructions 101 may be inputted into the rename module 404. The reorder buffer 403 may be inputted into the rename module 404. The rename module 404 may rename the instructions based on the reorder buffer 403. When a load is predicted (matched value table (VT) entry with saturated confidence counter) a MOVI uop 510 may be injected before rename 404. The apparatus may input the predicted value 408 by means of a move operation 510 (shown in FIG. 5). The apparatus 800 may be configured to use the load value 605 as a predicted value 408 for the corresponding instruction 101 by injecting a further instruction to write the predicted value 408 in the destination register of the corresponding instruction 101. The corresponding instruction 101 may be the instruction 101 which outputs the load value 605 (as described herein) in question. The further instruction may be a move operation 510. The further instruction may be a MOVI uop 510. The move operation 510 may be inputted into the rename module 404. The rename module 404 may rename the instructions 101 in dependence on the move operation 510. The move operation 510 may write the predicted value 408 in physical register file (PRF), which may trigger the existing instruction scheduling and execution engine for waking up the respective consumers of the predicted load. The PRF write ports may be shared between the predicted load and the move operation 510. The predicted load may be treated as a load-acquire uop to guarantee memory consistency. The outcome may be effective legacy compliant PRF-based communication of predicted load values 510 to consumers.

The apparatus may dispatch the renamed instructions 101 for execution. The pipeline 400 may comprise a dispatch module 405. The dispatch module 405 may receive the renamed instructions 101 and dispatch 405 them for execution.

The apparatus may execute the instructions 101. The pipeline 400 may comprise an execution module 406. The execution module 406 may execute 406 the instructions 101. The instructions 101 may be executed 406 based on the ROB 403. The instructions 101 may be executed 406 based on the ROB 403 so as to carry out concurrent instruction execution. The execution module 406 may output the load value of each of the instructions 101 executed.

FIG. 5 schematically illustrates an exemplary concurrent instruction execution pipeline 400 including details of the value prediction unit 407 of the present application. The description in relation to the value prediction unit 407 relates to a single load value for a single instruction 101. The description may equally relate to a plurality of load values for corresponding instructions 101.

The value prediction unit 407 may obtain a load value 511. The value prediction unit 407 may obtain the value written back by an executed load instruction (hereinafter denoted shortly as “load value”). The value prediction unit 407 may obtain a load value 605 of an executed instruction 101. The load value 511 may be received from the execution unit 406. The value prediction unit 407 may comprise an update value table (UVT) 501. The load value 511 may be received by the UVT 501. The load value 511 may be PUSHED from the predictor in the UVT 501. The UVT 501 may be an array used to store predicted values and context per load uop to be used for training and validation during the pipe. The UVT 501 may convey to the value predictor unit 407 the necessary update information. The outcome of the UVT 501 may be cost-effective training with correct value/context communication.

The value prediction unit 407 may comprise a value table (VT) hit 502. The VT hit 502 may receive the load value 605 from the UVT 501.

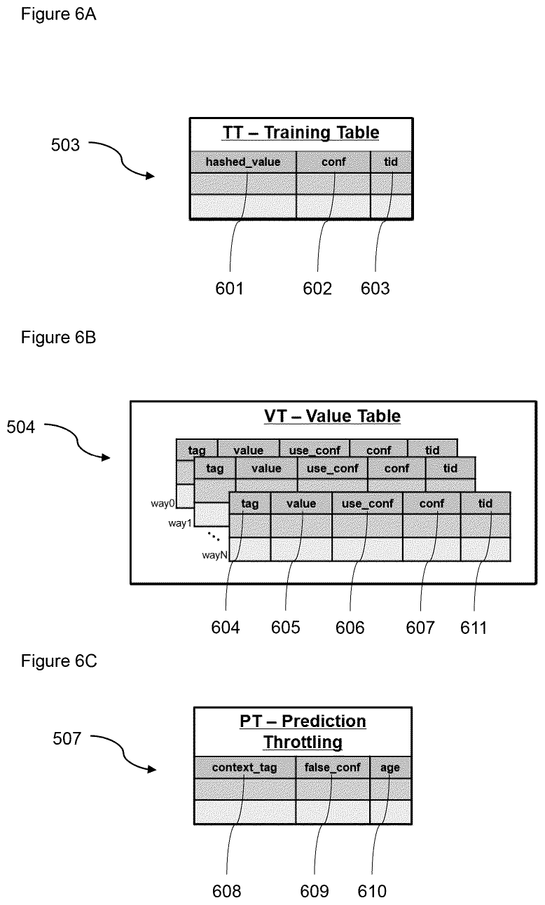

FIG. 6A shows an exemplary training table 503 of the present application. The value prediction unit 407 may comprise the training table 503. The apparatus may enter the load value 511 into the training table 503. The VT hit 502 may input the load value 511 into the training table 503. The apparatus may input at least part of the load value 511 into the training table 503. In other words, not all of the information that makes up the load value 511 may be inputted into the training table 503. A folded hash 601 of the load value 511 may be inputted into the training table 503. The folded hash 601 may break up the load value 511 into segments that are added to form a hash value.

Training Table (TT) 503 may comprise an array used for filtering loads, indexed by a hash of the load program counter (PC)+branch history register (BHR) context. The table entries store a small hash 601 of the load instruction 101 writeback (WB) values and a short counter to record the number of WB value recurrences as a confidence indicator 602. The purpose of the TT 503 may be to study all loads in the program but pass to the value table (VT) 504 only a small fraction of the loads that prove to be relatively stable, i.e., predictable.

The training table 503 may filter load instructions with recurrent values. The load values 511 may be indexed with a hash of the load PC and the selected context (ctx), such as branch history. Each entry in the training table 503 may contain a folded hash 601 of the most recent load value 511 of the load instruction 101, a conf. counter 602 and the tid 603. There may be direct replacement when the entry's folded value hash 601 does not match the hash of the actual value produced by the instruction. During replacement, the conf. counter 602 may be reset. The conf. counter 602 may increase when the folded value hash 601 in the training table 503 matches the hash of the actual value produced by the instruction 101.

The load value 511 may comprise a training table confidence level 602. The load value 511 may comprise a training table count value. The training table count value may comprise the number of load values 511 for the corresponding executed instruction 101 that have been previously inputted into the training table 503. In other words, each time the same instruction 101 is executed, the output load value 511 may be inputted into the training table 503, and each time a count is added to the training table count value. Each time the folded value hash 601 is equal to the new hashed value, the count is added. The training table confidence level 602 may be dependent on the training table count value. The training table confidence level 602 may be correlated to the training table count value. In other words, each time the training table count value increases, the training table confidence level 602 may increase. The training table confidence level 602 may start at zero when the training table count value is zero. Alternatively, the training table confidence level 602 may not be dependent on the training table count value. The training table confidence level 602 may be on other criteria.

The apparatus may replace a previous load value 511 in the training table 503 with the current load value 511. The previous at least part 601 of the load value 511 may be replaced with the current at least part 601 of the load value. In particular, the previous folded hash value 601 may be replace with the current folded hash value 601. The value, be it a load value 511, part 601 of the load value, or a folded hash value 601, may be replaced in dependence on the current load value 511 differing from the previous load value 511. In other words, if the instruction 101 outputs a different load value 511 when executed, then the training table 503 value 601 may be updated. The previous load value 511 is that already stored in the training table 503. The current load value 511 is that currently outputted by the instruction 101. If the value 601 in the training table 503 is replaced, then the training table confidence level 602 may be reset to zero. In other words, if the training table value 601 is incorrect, then the confidence in the replaced value 601 starts at zero.

FIG. 6B shows an exemplary value table 504 of the present application. The value prediction unit 407 may comprise the value table 504. The apparatus may input the load value 605 into the value table 504. The training table 503 may output the load value 605 into the value table 504. Instructions may allocate a value-table-entry only after the respective training-table-entry 601 has reached the confidence threshold. Allocation to the value table 504 may be triggered at the same cycle that the conf. counter 602 gets saturated. The outcome may be storage-effective, that is isolated from the value table 504 (the main value-cache of the predictor 407), filtering of load instructions that have very short intervals of recurrent values.

The training table 503 may output the load value 605 to the value table 504 in dependence on the training table confidence level 602 being above a training table confidence threshold. If the training table confidence level 602 is above the training table confidence threshold, the training table 503 may output the load value 605 to the value table 504. In other words, once the training table value 601 reaches a high enough level of confidence 602 that it will accurately predict the load value 605, the load value may be inputted into the value table 504. A full load value 605 may be entered into the value table 504. In other words, the folded hash load value 601 may not be inputted into the value table 504, and instead the full load value 605 may be inputted into the value table 504.

Alternatively, or in addition, the VT hit 502 may input the load value 605 into the value table 504. If the instruction 101 and the corresponding load value 605 is known by the value prediction unit 407, then the VT hit 502 may input the load value 605 into the value table 504. The VT hit 502 may input the load value 605 into the value table 504 if the corresponding load value 605 has a high enough confidence level that it is not required to be inputted into the training table 503.

The value table 504 may comprise one or more load values 605 of one or more instructions 101 which may be used as predicted values 408 in concurrent instruction execution 406. In other words, the value table 504 may provide a resource to be used when the concurrent instruction execution 406 intends to use predicted values 408. The training table 503 may provide a training area in which the confidence in the load values 605 can be built up before they are inputted into the value table 504 for use as predicted values 408.

The value table 504 may comprise an array used to train only on loads that passed the filtering by recording and checking the stability of their full value, tagging it with the PC, and counting recurrences up to a higher confidence (~40×) threshold.

The value table 504 may cache the recurrent values of load instructions. The value table 504 may be organized as an interleaved set-associative memory banked by the load's offset in the fetch block 401. The value-prediction-unit may be accessed and provide predictions for multiple instructions in parallel (i.e. at the same clock cycle). The number of the parallel predictions may be equivalent to the number of blocks. The value table 504 may be indexed with a hash of the load PC and the selected context (ctx)-branch history-masked to the number of sets. The produced set index may probe each way searching for a tag match. Each entry may contain the recurrent load value 605, a tag 604, a confidence (conf.) counter 607 and a utility confidence (use_conf) counter 606. Both counters may be reset when the value 605 does not match the actual value produced by the instruction 101. Otherwise, the counters 606, 607 maybe increased with each entry of the same value 605. An entry may be be replaced when its use_conf counter 606 is equal to zero. If the tag-matched entry has conf. 607 over the threshold, the value 605 may be read and the VT hit-flag in the uop payload may be activated. The outcome may be effective context-based caching (learning) of recurrent load values.

The load value 605 may comprise a value table confidence level 607. The load value 605 may comprise a value table count value 606. The value table count value 606 may comprise the number of load values 605 for the corresponding executed instruction 101 that have been previously inputted into the value table 504. In other words, each time the same instruction 101 is executed, the output load value 605 may be inputted into the value table 504, and each time a count is added to the value table count value 606. The value table confidence level 607 may be dependent on the value table count value 606. The value table confidence level 607 may be correlated to the value table count value 606. In other words, each time the value table count value 606 increases, the value table confidence level 607 may increase. The value table confidence level 607 may start at zero when the value table count value 606 is zero.

If the current load value differs from the previous load value 605 in the value table 504, then the value table confidence 607 may reduce. The amount the value table confidence 607 may reduce may depend on how different the current load value is from the previous load value 605 in the value table 504. The entries of TT 503 and VT 504 may contain additional bits such as “valid” bit and “replacement policy” bits to help managing the storage and the replacement operations on the microarchitectural level.

The apparatus may replace a previous load value 605 in the value table 504 with the current load value. The load value 605 may be replaced in dependence on the current load value differing from the previous load value 605. In other words, if the instruction 101 outputs a different load value 605 when executed, then the load value 605 may be updated. The previous load value 605 is that already stored in the value table 504. The current load value is that currently outputted by the instruction 101. If the load value 605 in the value table 504 is replaced, then the value table confidence level 607 may be reset to zero. In other words, if the load value 605 is incorrect, then the confidence in the replaced load value 605 starts at zero.

The apparatus may use the load value 605 in the value table 504 as a predicted value 408 for the corresponding instruction 101 during execution 406. When an instruction searches for an entry in VT either to predict its value or to update with its new value, there should be a tag 604 and tid 611 match with the requested entry to use it. The apparatus may use the load value 605 in the value table 504 as a predicted value 408 for the corresponding instruction 101 during execution 406 in dependence on the load value 605 having a value table confidence level 607 above a value table confidence threshold. In other words, the load value 605 may only be used as a predicted value 408 if the confidence in the accuracy of the load value is high enough. The value table 504 may only output the load value 605 if the value table confidence level 607 above a value table confidence threshold. The value table confidence threshold may vary for different load values 605 in the value table 504. For example, load values 605 for more destructive instructions 101 may have a higher value table confidence threshold. The value table 504 may output the load value 605 to a gating unit 508, controlled by the prediction throttling 507.

The apparatus 800 may use a load value 605 in the value table 504 as a predicted value 408 for the corresponding instruction 101 in the concurrent instruction execution 406 in dependence on the context 604 of the corresponding instruction 101 in the concurrent instruction execution 406 matching the context 604 of the load value 605 in the value table 504. The context 604 may comprise branch history of the corresponding instruction 101. If there are no load values 605 which comprise a context 604 which matches the corresponding instruction 101, a load value may not be used as a predicted value. In other words, the apparatus 800 may check if there is a load value 605 in the value table 504 which has the required context 604.

The apparatus 800 may use a load value 605 in the value table 504 as a predicted value 408 for the corresponding instruction 101 in the concurrent instruction execution 406 in dependence on the tid 611 of the corresponding instruction 101 in the concurrent instruction execution 406 matching the tid 611 of the load value 605 in the value table 504. If there are no load values 605 which comprise a tid 611 which matches the corresponding instruction 101, a load value may not be used as a predicted value. In other words, the apparatus 800 may check if there is a load value 605 in the value table 504 which has the required tid 611.

The pipeline 400 may comprise a bank board 505. The bank board 505 may receive the instructions 101 to be executed. The bank board may control the available VT 504 read-access ports. VT 504 ways may be grouped into the available banks in a binary table (the bank board 505). False means that the requested bank for accessing the specified VT way to read the predicted value is busy during this cycle. The entries may be reset every time at the end of decode. The outcome may be cost-effective control of VT read accesses for enabling the prediction of multiple loads within the same cycle. In other words, the bank board 505 may control which instructions 101 are provided with load values 605 as predicted values 408. The control may depend on the availability of the value table 504.

FIG. 6C shows an exemplary prediction throttling table 507 of the present application. The pipeline 400 may comprise a prediction throttling unit 507. The prediction throttling unit 507 may receive the instructions 101 which have passed through the bank board 505. The prediction throttling unit 507 may control the use of load values 605 as predicted values 408 based on previous mispredictions. The prediction throttling unit 507 may control the use of load values 605 as predicted values 408 using an auxiliary gating unit 508. The prediction throttling table 507 may comprise an array used for tracking program contexts that lead to pipeline squashes due to value mispredictions. The purpose of prediction throttling table 507 may be to prevent future instructions from predicting their value when the same context is observed. The prediction throttling unit 507 may be indexed with the selected context (ctx), such as branch history. Each entry may contain a tag 608 (being the selected context), a conf. counter 609 and an age counter 610. When the context matches the tag 608 of an entry, prediction may be prevented. In other words, the load value 605 is not used as a predicted value 408. In the case that the load value 605 is not used as a predicted value 408, the load value 605 may be saved in the UVT 501 to enable update of the predictor 407 as a later point. The apparatus 800 may use the load value 605 from the value table 504 as a predicted value 408 for the corresponding instruction 101 in the concurrent instruction execution 406 in dependence on the context of the corresponding instruction 101 in the concurrent instruction execution 406 differing from the context 608 in a prediction throttling table 507 for the corresponding instruction 101. The prediction throttling table 507 may comprise one or more context 608 in which the load value 605 of the corresponding instruction 101 has previously been incorrectly predicted. The context 608 may comprise branch history of the corresponding instruction 101. If the predicted value 408 was correct but there was a tag match, the false_conf 409 is increased. When false_conf is over the threshold, the entry may be reset. Age counters 610 may be normalized based on the minimum age and control the entries eviction/replacement. An entry may be allocated with a tag 608 equal to the context that had been observed when a value misprediction triggered a pipeline squash/recovery. The outcome may be effective prevention of value mispredictions observed with the same program context.

The apparatus may use the load value 605 in the value table 504 as a predicted value 408 for the corresponding instruction 101 in the concurrent instruction execution 406 in dependence on the context of the corresponding instruction 101 in the concurrent instruction execution 406 differing from the context 608 of the load value 605 in the value table 504. In other words, if the context of the current instruction 101 is the same as a previous instruction 101 which previously mispredicted, then load value 605 may not be used as a predicted value 408. The context 608 may comprise branch history of the corresponding instruction 101. If the instruction 101 passes the requirements of the prediction throttling unit 507, then the load value 605 may be used as a predicted value 408.

The pipeline 400 may comprise a zero-one elimination (ZOE) unit 509. For every instruction decoded at 402, the ZOE unit 509 may obtain the instruction's decoded information which may include the operation code and its source register identifiers. The ZOE unit 509 may comprise a mechanism that writes predicted zero/one values directly to the register rename process and enables speculative elimination of simple operations that become redundant when one of the operands is 0 or 1 (such as multiply by 0 or 1, add 0, shift by 0, etc.). The ZOE elimination mechanism may be enabled by predicted register values (PRF). PRF may be extended with a two-bit ZOE flag: 00/01/not-valid. The ZOE flags may assign to registers when their values are predicted. Instructions check the ZOE-flag of their source (src) registers at decode time to identify one or more of the following cases:
mul with 0
div 0
add 0
AND with 0
OR with 0
XOR with 0
LS with 0
mul with 1
div by 1
   Other cases may be possible. Elimination may occur for all of the above cases by injecting a respective move or move immediate operation (such as a MOV/MOVI operation) accordingly. The outcome may be effective use of the predicted values for preventing redundant operations. In dependence on an instruction 101 in the concurrent instruction execution inherently defining the same value irrespective of the input, the apparatus 800 may be configured to use the value of the instruction in the concurrent instruction execution 406 without executing the instruction. In other words, if the instruction 101 always outputs the same load value 605, then that load value may be used. The ZOE unit 509 may be used to determine which instructions 101 always output the same load value 605.

The present system may be applicable to any microprocessor (CPU) design that features an execution pipeline with either in-order or out-of-order (OoO) execution of incoming program instructions 101. The general representation of such a design augmented with the value prediction mechanism is shown in FIG. 4. Instructions 101 may be fetched 401 from the processor's memory (not shown in FIG. 4 for simplicity) and then decoded 402 into respective uops. Load uops may then be predicted by accessing the value predictor structures 407 (depicted as one single component in FIG. 4 for simplicity). The predicted values of load uops may be communicated to the consumers in the way that has been described before (see Section 4.2). All uops, including the predicted loads, may continue to flow normally in the pipeline 400 from left to right and are scheduled for execution when their operands are ready. When executed, predicted loads, may verify their prediction and update accordingly the value predictor 407. If their prediction was used by other consumer instructions (i.e., when the prediction had saturated confidence) and it was wrong, then the correct value may be written in the PRF and execution may recovered by squashing the pipeline 400. If the prediction was correct, then the execution flow may continue uninterrupted. All uops may be eventually retired/committed in program order to maintain program semantics (not shown in FIG. 4 for simplicity). Instructions that are not loads may benefit by using predicted data and the ZOE mechanism so that their execution may be skipped.

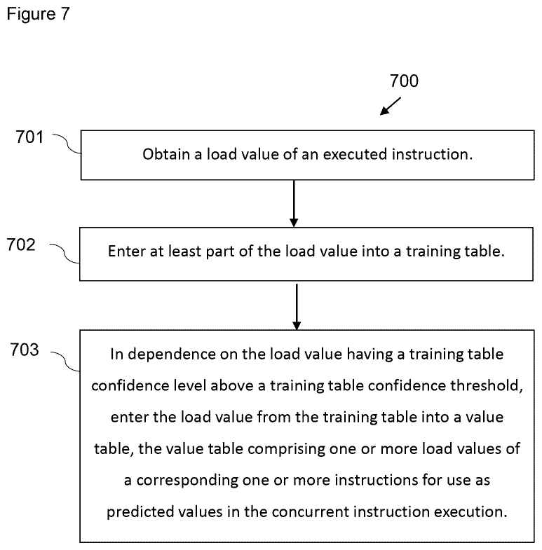

FIG. 7 summarises an example of a method 700 for value prediction in concurrent instruction execution. At step 701, the method 700 comprises obtaining a load value of an executed instruction. At step 702, the method 700 comprises entering at least part of the load value into a training table. At step 703, the method 700 comprises in dependence on the load value having a training table confidence level above a training table confidence threshold, entering the load value into a value table, the value table comprising one or more load values of a corresponding one or more instructions for use as predicted values in the concurrent instruction execution.

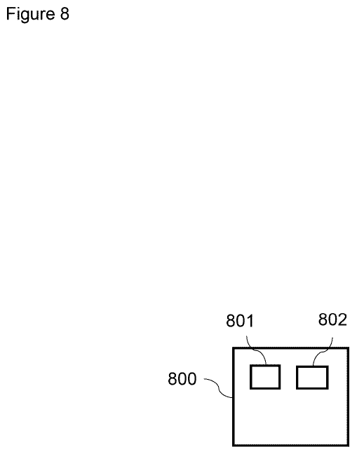

An example of an apparatus 800 configured to implement the method 800 is schematically illustrated in FIG. 8. The computing apparatus 800 may comprise the pipeline 400. The apparatus 800 may be implemented on an electronic device, such as a computer, laptop, tablet, or smart phone.

The apparatus 800 comprises a processor 801 configured to process the datasets in the manner described herein. For example, the processor 801 may be implemented as a computer program running on a programmable device such as a Central Processing Unit (CPU). The apparatus 800 comprises a memory 802 which is arranged to communicate with the processor 801. Memory 802 may be a non-volatile memory. The processor 801 may also comprise a cache (not shown in FIG. 8), which may be used to temporarily store data from memory 802. The apparatus may comprise more than one processor and more than one memory. The memory may store data that is executable by the processor. The processor may be configured to operate in accordance with a computer program stored in non-transitory form on a machine-readable storage medium. The computer program may store instructions for causing the processor to perform its methods in the manner described herein. The method steps described herein may be carried out by a computer-readable storage medium. The method steps described herein may be carried out by a computer program product.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description, it will be evident to a person skilled in the art that various modifications may be made within the scope of the invention.

What is claimed is:

1. A computing apparatus for value prediction in concurrent instruction execution, the computing apparatus comprising one or more processors and a memory storing program code, wherein the program code is executable by the one or more processors so that the computing apparatus is configured to:
obtain a load value of an executed instruction;
enter at least part of the load value into a training table; and
in dependence on the load value having a training table confidence level above a training table confidence threshold, enter the load value into a value table, the value table comprising one or more load values of a corresponding one or more instructions for use as predicted values in the concurrent instruction execution.

2. The computing apparatus according to claim 1, wherein the apparatus is configured to enter a folded hash of the load value into the training table.

3. The computing apparatus according to claim 1, wherein the training table confidence level (602) is based on a training table count value of previous load values for the corresponding executed instruction entered into the training table.

4. The computing apparatus according to claim 1, wherein the apparatus is configured to replace a previous at least part of the load value for the executed instruction in the training table with the current at least part of the load value for the executed instruction in dependence on the current load value (511) differing from the previous load value.

5. The computing apparatus according to claim 1, wherein the apparatus is configured to enter a full load value into the value table.

6. The computing apparatus according to claim 1, wherein the apparatus is configured to use a load value in the value table as a predicted value for the corresponding instruction in the concurrent instruction execution, and optionally wherein the apparatus is configured to use the load value in the value table as a predicted value for the corresponding instruction by injecting a further instruction to write the predicted value in the destination register of the corresponding instruction.

7. The computing apparatus according to claim 6, wherein the apparatus is configured to use a load value in the value table as a predicted value for the corresponding instruction in the concurrent instruction execution in dependence on the load value having a value table confidence level above a value table confidence threshold.

8. The computing apparatus according to claim 7, wherein the value table confidence level is based on a value table count value of previous load values for the corresponding executed instruction entered into the value table.

9. The computing apparatus according to claim 7, wherein the apparatus is configured to reduce the value table confidence level for the load value in dependence on the current load value differing from the previous load value.

10. The computing apparatus according to claim 6, wherein the apparatus is configured to use a load value in the value table as a predicted value for the corresponding instruction in the concurrent instruction execution in dependence on the context of the corresponding instruction in the concurrent instruction execution matching the context of the load value in the value table, and optionally wherein the context comprises branch history of the corresponding instruction.

11. The computing apparatus according to claim 6, wherein the apparatus is configured to use the load value from the value table as a predicted value for the corresponding instruction in the concurrent instruction execution in dependence on the context of the corresponding instruction in the concurrent instruction execution differing from the context in a prediction throttling table for the corresponding instruction, the prediction throttling table comprising one or more context in which the load value (605) of the corresponding instruction has previously been incorrectly predicted, and optionally wherein the context comprises branch history of the corresponding instruction.

12. The computing apparatus according to claim 1, wherein in dependence on an instruction in the concurrent instruction execution inherently defining the same value irrespective of the input, the apparatus (800) is configured to use the value of the instruction in the concurrent instruction execution without executing the instruction.

13. The computing apparatus according to claim 1, wherein the apparatus (800) is configured to fetch a plurality of instructions to be executed in an order, and optionally wherein the apparatus is configured to decode each of the plurality of instructions.

14. The computing apparatus according to claim 13, wherein the apparatus is configured to order the decoded plurality of instructions in a re-order buffer in dependence on predicted values for the plurality of instructions available for use from the value table, and optionally wherein the apparatus is configured to execute the plurality of instructions based on the re-order buffer so as to carry out the concurrent instruction execution.

15. A method for value prediction in concurrent instruction execution, the method comprising steps of:
obtaining a load value of an executed instruction;
entering at least part of the load value into a training table; and
in dependence on the load value having a training table confidence level above a training table confidence threshold, entering the load value into a value table, the value table comprising one or more load values of a corresponding one or more instructions for use as predicted values in the concurrent instruction execution.
